(19) United States
(12) Patent Application Publication
(10) Pub. No.: US 2010/0053092 A1
(43) Pub. Date: Mar. 4, 2010

(54) Control Method for Touch Screen Device

(75) Inventors: Hsiang-Yi Chen, Hsin-Chu (TW); Yao-Jen Hsieh, Hsin-Chu (TW); Heng-Sheng Chou, Hsin-Chu (TW); Ming-Jong Jou, Hsin-Chu (TW); Shih-Yi Liao, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/263,554

(22) Filed: Nov. 3, 2008

(30) Foreign Application Priority Data
Aug. 26, 2008 (TW) 97132564

(51) Int. Cl. G06F 3/041

(52) U.S. Cl. 345/173

(57) ABSTRACT

A control method for a touch screen device is provided. The control method comprises the steps of: enabling an active mode of a touch panel; defining at least one active area on the touch panel; inputting a touch input into any one position on the touch panel; determining whether the touch input exists in the active area; and saving calculation of coordinate values of the position corresponding to the touch input and outputting a corresponding predetermined output signal in accordance with the touch input when the touch input exists in the active area.

### RELATED APPLICATIONS

This application claims priority to Taiwan Patent Application Serial Number 97132564, filed Aug. 26, 2008, which is herein incorporated by reference.

### BACKGROUND

1. Field of Invention

The present invention relates to a touch screen device. More particularly, the present invention relates to a control method for a touch screen device.

2. Description of Related Art

For a conventional touch screen device, the usual control manner is to perform or press a touch input on the touch panel first, and then to analyze and calculate coordinate values corresponding to the touch input on the touch panel, so as to confirm the position of the touch input and the selected object thereof and to execute the process performed by users.

However, since the touch screen device has to analyze and calculate the coordinate values corresponding to each touch input, the touch screen device, when working, will not only consume many operation resources such that the efficiency of the system decreases but also lose lots of power.

### SUMMARY

In accordance with one embodiment of the present invention, a control method for a touch screen device is provided. The control method comprises the steps of: enabling an active mode of a touch panel; defining at least one active area on the touch panel; inputting a touch input into any one position on the touch panel; determining whether the touch input exists in the active area; and saving calculation of coordinate values of the position corresponding to the touch input and outputting a corresponding predetermined output signal in accordance with the touch input when the touch input exists in the active area.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference to the accompanying drawings as follows:

FIG. 1 illustrates a flow chart of a control method for a touch screen device according to one embodiment of the present invention;

FIGS. 2A, 2B and 2C illustrate manners of controlling the touch screen device according to one embodiment of the present invention; and

FIG. 3 illustrates yet another manner of controlling the touch screen device according to one embodiment of the present invention.

### DESCRIPTION OF THE PREFERRED EMBODIMENTS

In the following detailed description, the embodiments of the present invention have been shown and described. As will be realized, the invention is capable of modification in various respects, all without departing from the invention. Accordingly, the drawings and description are to be regarded as illustrative in nature, and not restrictive.

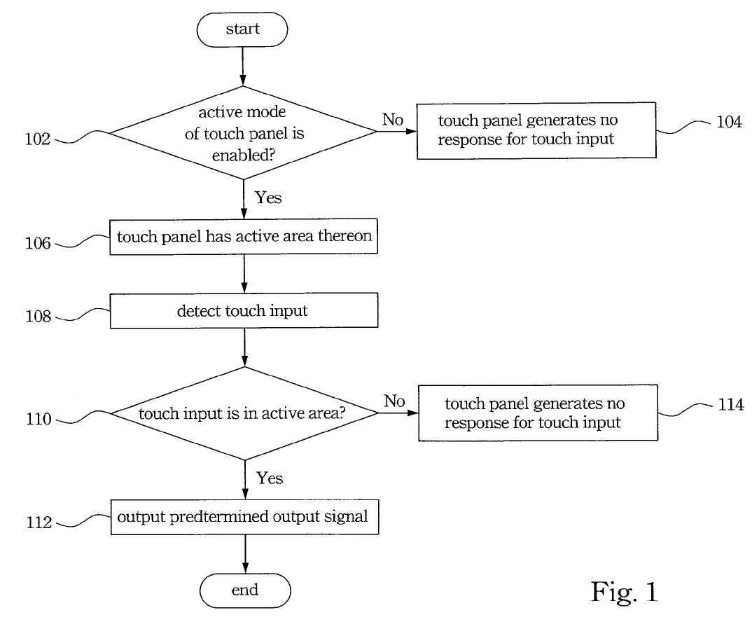

FIG. 1 illustrates a flow chart of a control method for a touch screen device according to one embodiment of the present invention. First, whether the active mode of the touch panel in the touch screen device is enabled is determined (Step 102). When the active mode of the touch panel is not enabled or disabled, the touch panel has no active area thereon and generates no response for the touch input or press performed by the user (Step 104). At that moment, the touch screen device is merely provided to display images.

On the other hand, if the active mode of the touch panel is enabled, the touch panel has at least one active area thereon (Step 106), in which the size and location of the active area shown on the touch panel can be changed or modified in advance according to the practice use, so as to meet the user's need. After that, the touch panel detects the touch input or press performed by the user (Step 108), and whether the foregoing touch input or press is in any position of the active area is then determined (Step 110). When the foregoing touch input or press exists in the active area, a predetermined output signal corresponding to the active area is outputted in accordance with the touch input (Step 112). Notably, the predetermined output signal can be directly outputted, without calculating the coordinate values of the position corresponding to the touch input, to be displayed on the touch panel. Also notably, the predetermined output signals corresponding to the same active area are the same. For instance, when the touch panel has a first and second active area thereon, a first predetermined output signal is outputted according to the touch input or press if the touch input or press is performed in any position of the first active area, in which the first predetermined output signal can be, for example, a character signal. If the touch input or press is performed in any position of the second active area, a second predetermined output signal is outputted according to the touch input or press, in which the second predetermined output signal also can be a character signal. Furthermore, when the touch input or press is outside the active area, the touch panel generates no response for the touch input or press performed by the user (Step 114).

In one embodiment, when the touch input is performed in any position of the active area, the touch panel detects the touch input to generate a corresponding input signal. Then, the input signal is processed by a firmware, and the firmware directly outputs the predetermined output signal corresponding to the active area after processing the input signal. Since the input signal corresponding to the touch input is processed by the firmware and the corresponding predetermined output signal is then directly outputted by the firmware, the system would not need to analyze and calculate the coordinate values of the position corresponding to the touch input. Therefore, the operation resource of the whole system can be saved. In one embodiment, the foregoing predetermined output signal is a machine code or machine language. The machine code or machine language is one kind of instruction set capable of being executed directly by the processing unit, that the computer designer configures the function to the computer through its hardware structure, which has advantages such as flexibility, direct execution and high speed. In addition, in another embodiment, the foregoing predetermined output signal is a character signal which can be an American Standard Code for Information Interchange (ASCII) code.

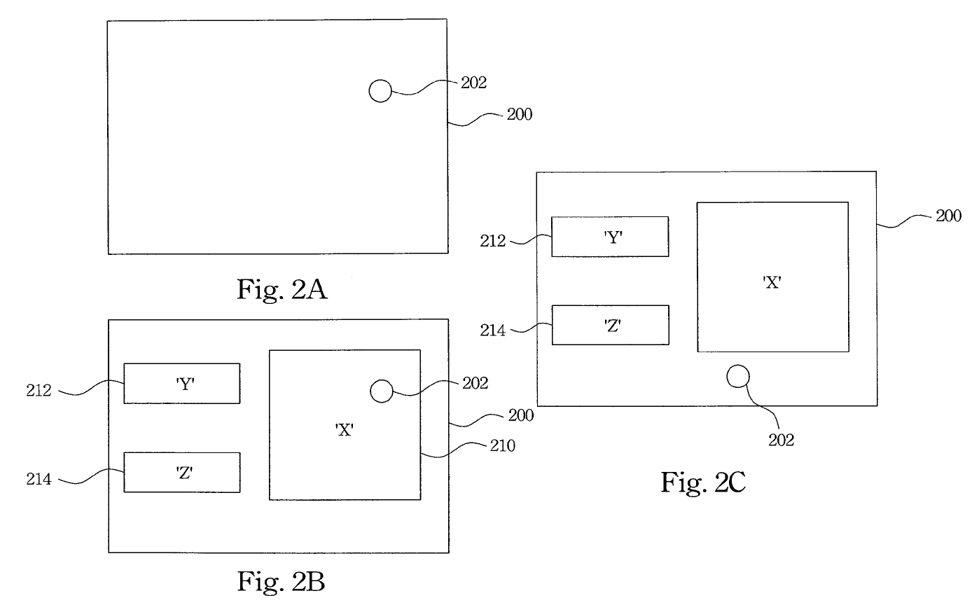

FIG. 2A illustrates a manner of controlling the touch screen device according to one embodiment of the present invention. As shown in FIG. 2A, since the active mode of the touch panel 200 is not enabled, the touch panel 200 has no active area thereon and would not detect the touch input performed by the user and thus generates no response for the touch input.

FIGS. 2B and 2C illustrate another manner of controlling the touch screen device according to one embodiment of the present invention. As shown in FIGS. 2B and 2C, when the active mode of the touch panel 200 is enabled, there are active areas 210, 212 and 214 displayed on the touch panel 200. Then, the touch panel 200 would detect the touch input 202 performed by the user, and then determine whether the touch input 202 is in one of the active areas 210, 212 and 214. For instance, if the touch input 202 is performed or pressed in the active area 210, the predetermined output signal (e.g. character X) corresponding to the active area 210 would be outputted to display on the touch panel 200. If the touch input 202 is performed or pressed outside the active areas 210, 212 and 214, the touch panel 200 generates no response.

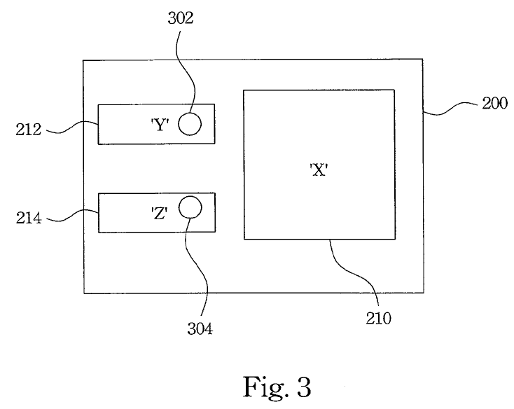

FIG. 3 illustrates yet another manner of controlling the touch screen device according to one embodiment of the present invention. Compared to FIG. 2B, the user performs two touch inputs 302 and 304 on the touch panel 200, and the touch panel 200 detects the touch inputs 302 and 304, respectively. At that moment, the touch panel 200 separately determines whether the touch inputs 302 and 304 exist in the active areas 210, 212 and 214. If the touch input 302 exists in the active area 212 and the touch input 304 exists in the active area 214, the predetermined output signals (e.g. characters Y and Z) corresponding to the active area 212 and 214, respectively, would be outputted to display on the touch panel 200. Similarly, if the touch inputs 302 and 304 are performed outside the active areas 210, 212 and 214, the touch panel 200 generates no response.

For the foregoing embodiments, the control method for the touch screen device can be provided for the user to mark out the active areas during operation, such that the touch inputs can be processed without calculating the corresponding coordinate values, so as to speed up the process of the system and make the whole process more convenient. Moreover, since the non-active area can even perform no detection, the power loss of the touch screen device can be thus reduced. In addition, the system needs not to analyze and calculate the coordinate values corresponding to the touch input, so the system operation resource can be saved.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A control method for a touch screen device, comprising:
enabling an active mode of a touch panel;
defining at least one active area on the touch panel;
inputting a touch input into any one position on the touch panel;
determining whether the touch input exists in the active area; and
saving calculation of coordinate values of the position corresponding to the touch input and outputting a corresponding predetermined output signal in accordance with the touch input when the touch input exists in the active area.

2. The control method of claim 1, wherein the predetermined output signal is directly outputted after an input signal corresponding to the touch input is processed by a firmware.

3. The control method of claim 1, wherein the predetermined output signal is a machine code.

4. The control method of claim 1, wherein the predetermined output signal is a character signal.

5. The control method of claim 4, wherein the character signal is an American Standard Code for Information Interchange (ASCII) code.

6. The control method of claim 1, further comprising:
the touch panel generating no output signal corresponding to the touch input when the touch input exists outside the active area.

7. The control method of claim 1, further comprising:
disabling the active mode, wherein the touch panel generates no output signal corresponding to any touch input when the active mode is disabled.

8. The control method of claim 1, further comprising:
displaying a plurality of active areas on the touch panel under the active mode;
detecting a first touch input and a second touch input performed on the touch panel;
determining whether the first touch input exists in any position of a first active area of the active areas or whether the second touch input exists in any position of a second active area of the active areas; and
when the first touch input exists in the first active area or the second touch input exists in the second active area, saving calculation of coordinate values of the position corresponding to the first or second touch input and outputting a first predetermined output signal corresponding to the first active area in accordance with the first touch input or a second predetermined output signal corresponding to the second active area in accordance with the second touch input.

9. The control method of claim 8, wherein the first or second predetermined output signal is directly outputted after a first input signal corresponding to the first touch input or a second input signal corresponding to the second touch input is processed by a firmware.

10. The control method of claim 8, wherein the first or second predetermined output signal is a machine code.

11. The control method of claim 8, wherein the first or second predetermined output signal is a character signal.

12. The control method of claim 11, wherein the character signal is an American Standard Code for Information Interchange (ASCII) code.

13. The control method of claim 8, further comprising:
when the first touch input exists outside the first active area or the second touch input exists outside the second active area, the touch panel generating no output signal corresponding to the first or second touch input.
